(19) United States
(12) Patent Application Publication
(10) Pub. No.: US 2015/0068898 A1
(43) Pub. Date: Mar. 12, 2015

(54) Measuring Membrane for an Optochamical or Amperometric Sensor

(71) Applicant: Endress + Hauser Conducta Gesellschaft für Mess- und Regeltechnik mbH + Co. KG, Gerlingen (DE)

(72) Inventors: Christian Fanselow, Geringswalde (DE); Andreas Lobbert, Waldheim (DE)

(21) Appl. No.: 14/482,188

(22) Filed: Sep. 10, 2014

(30) Foreign Application Priority Data
Sep. 12, 2013 (DE) 10 2013 110 040.6

(51) Int. Cl. G01N 27/40; G01N 21/75

(52) U.S. Cl. CPC G01N 27/40; G01N 21/75
USPC 204/415; 422/82.07

(57) ABSTRACT

A measuring membrane for an optochemical or amperometric sensor for determining or monitoring an analyte located in a medium, comprising a substrate material and a sensor element, which has at least one functional layer with a sensor-specific substance. The sensor element is embedded completely in a matrix, and the matrix is composed of a material, which at least in a portion facing the medium and adjoining the sensor element is permeable for the analyte.

The invention relates to a measuring membrane for an optochemical or amperometric sensor for determining or monitoring an analyte located in a medium utilizing a sensor element, which comprises: at least one functional layer with a sensor-specific substance; and a substrate material. Furthermore, the invention relates to a sensor cap and an optochemical or amperometric sensor.

An optochemical analyte sensor, e.g. an oxygen sensor, rests on the principle of analyte induced fluorescence- or luminescence quenching of an organic colorant carried e.g. in a polymer matrix. Usually, the polymer/colorant mixture adapted for a predetermined analyte is applied as a solid film on a substrate, e.g. on a glass platelet or on an optical fiber.

Known from WO 2005/100 957 A1 is an apparatus for determining and/or monitoring an analyte contained in a fluid process medium. The known apparatus includes a sensor with a measuring membrane, which possesses a porous support structure. Embedded in the support structure is a luminescing substance contacting the process medium. Further provided are a transmitting unit and a receiving unit, wherein the transmitting unit transmits measuring radiation and excites the luminescing substance such that it emits luminescent radiation, and wherein the receiving unit detects the correspondingly produced luminescent radiation. A control/evaluation unit ascertains based on the quenching of the luminescent radiation of the luminescing substance the concentration, respectively the partial pressure/pressure, of the analyte in the process medium. The terminology, luminescence, refers to the production of optical radiation in a substance upon transition from an excited state into base state.

Likewise US 2003/0068827 A1 describes an optical sensor. While usually a form-stable support layer is used with a luminescing, membrane forming substance, in this US application a solution is described, in the case of which a support structure is embedded into the polymer/colorant matrix permeable for the analyte. This technology provides two advantages compared with the luminescing substance applied on a carrier: On the one hand, the matrix embedded in the membrane causes an increased scattering of the measuring radiation in the membrane and, thus, an increased luminescent radiation; on the other hand, the stability of the membrane is greater as a result of the seated support structure. Especially, the matrix is a glass fiber filter, which is soaked with the luminescing substance. Named as other materials for the matrix are cellulose, cellulose acetate and nylon. For manufacturing the membrane, the support structure is immersed in the luminescing substance and the excess luminescing substance subsequently so dried off that the luminescing substance jackets the individual fibers as a cladding. Spaces between the individual fibers remain free of luminescing substance.

Furthermore, it is known from U.S. Pat. No. 5,057,277 to embed the luminescing substance in silicone. For this, for the purpose of stability, the silicone is mixed with a fill material. The fill material is e.g. a silicate. Furthermore, a luminescing substance is introduced into the silicone. This structure thus involves a matrix, respectively a support structure, of silicone and a silicate.

Known from DE 100 51 220 A1 are an optical sensor for determining an analyte, especially oxygen, and a method for manufacture. The known optical sensor comprises a sensor matrix formed essentially of a fluoropolymer. The sensor matrix contains a luminescence indicator, which contains a metal complex of ruthenium, rhenium, rhodium or iridium and at least one partially fluorinated ligand. The sensor matrix is embodied foil-like and provided with a protective layer. The protective layer is manufactured preferably of the same material as the sensor matrix, but does not contain a luminescence indicator. In this way, a direct contact between the edge regions of the sensor matrix and the measured medium is prevented. Mechanical damage of the sensor matrix by abrasive particles in the process medium is prevented.

Laminar layer structures, such as, for example, those mentioned above, are suitable for optoelectric sensors and are referred to as measuring membranes or sensor spots. Either these are sold directly e.g. to biotech firms and food companies, or they are supplied to sensor manufacturers for the manufacture of so-called sensor caps. In part, the measuring membranes, respectively sensor spots, are also produced and sold directly by sensor firms.

For the manufacture of an optical measuring membrane for industrial automation technology, as a rule, an analyte permeable membrane is used, which has a certain chemical resistance to hot alkaline solutions and acids. Thus, applied in the foods industry for cleaning the sensors are alkaline solutions such as sodium hydroxide or potassium hydroxide solution at temperatures in the range of about 40° C. to 90° C. with a pH-value in the range of about pH13 to pH14 or strong acids with a pH-value in the range of about pH0 two pH1. In regular cycles, the sensor, especially the sensor cap, is exposed to these extreme conditions. After a certain residence time (dependent on cap design and sensor material) of the sensor in the aggressive cleaning media, delamination of individual layers of the measuring membrane or the dissolving out of individual particles from the measuring membrane can be experienced. As a result of this damage, the sensor loses its ability to function. Added to this is the fact that the dissolved out membrane parts contaminate the measured solution.

Measuring membranes applied in automation technology, which are suitable for optical and amperometric sensors, are composed of a layer structure of various materials, which have the different properties necessary for the ability of the sensor to function. Thus, a first layer of the layer structure e.g. provides a selective analyte permeability, a second layer cares for the chemical and/or mechanical stability of the measuring membrane, and a third layer emits upon corresponding excitation a fluorescence- or phosphorescence signal at a certain wavelength and an analyte specific phase angle, or it absorbs light. Sensors with corresponding measuring membranes are produced and sold by the applicant.

The known lamellar construction of a measuring membrane is not without problems. As already earlier stated, it can occur that individual layers can delaminate after a certain residence time—especially at high temperatures (>40° C.) and extreme pH-values (pH<2, pH>12) of the cleaning media. Usual accompanying substances of the cleaning media, such as alcohols or oxidizing media such as hypochlorites, can accelerate the aging of the measuring membrane further. They can lead to delamination or destruction of individual layer(s) of the lamellar structure, since they can, in given cases, release aggressive gases. The known lamellar construction of the functional layers can, in this way, lead to a deterioration of the measuring membrane and to a dissolving out of membrane parts into the measured medium.

An object of the invention is to provide a measuring membrane and a sensor cap for an optoelectrical or amperometric sensor of industrial automation technology, wherein the sensor maintains its functional ability under demanding environmental conditions.

The object is achieved by a measuring membrane for an optochemical or amperometric sensor for determining or monitoring an analyte located in a medium, wherein the measuring membrane is composed of a substrate material and a sensor element, which has at least one functional layer with a sensor-specific substance, wherein the sensor element is embedded completely in a matrix, and wherein the matrix is composed of a material, which at least in a portion facing the medium and adjoining the sensor element is permeable for the analyte. The terminology ‘analyte’ means in connection with the invention any form of ions or gases located in liquids.

In a first embodiment of the measuring membrane of the invention, the matrix is connected in at least one of its surface regions physically or chemically with the substrate material. Usual methods are used for connecting matrix material and substrate material.

An alternative embodiment provides that also the substrate material is at least partially embedded in the matrix and, in given cases, is embodied analyte permeably. In this way, a form-stable and robust sensor membrane can be manufactured. Depending on embodiment of the material of the matrix, the measuring membrane can be joined into a sensor cap, without supplemental sealing elements being needed.

A preferred solution of the measuring membrane of the invention provides that the sensor element has a layer structure and is composed of at least two functional layers, wherein one of the functional layers contains the sensor-specific substance, respectively is composed of the sensor-specific substance.

In an advantageous further development of the measuring membrane of the invention, the sensor-specific substance is selectively permeable for the analyte. In this case, also the material of the matrix is embodied at least in portions analyte permeably.

Alternatively, it is provided that the sensor-specific substance is formed in such a manner that it is changed in at least one of its chemical or physical properties by contact with the analyte, wherein the change is subsequently detectable with a corresponding detector unit.

Preferably, the material of the matrix is so embodied that it is chemically and/or physically stable—thus in high measures resistant—relative to the measured medium and/or a cleaning medium. For example, the material of the matrix can be silicone. Moreover, it is advantageous to have the material, of which the matrix is manufactured, be suitable for applications in the foods field. Especially in this connection, FDA guidelines should be followed.

In an advantageous further development of the measuring membrane of the invention, the substrate material is composed preferably of one of the following materials: glass, ceramic, polymer, metal organic compound, metal organic frame, and zeolite. Of course, also usable as substrate material can be a composition, which especially is composed of at least two of the aforementioned materials. In order to increase the form stability of the measuring membrane, in the case of both of the above solutions, also a support grating and/or a holding grating can be provided, which is embedded in the matrix.

If it is desired to apply the measuring membrane of the invention in the case of an amperometric sensor, then it is provided that the substrate material has a cavity in a region, in which the sensor-specific element is arranged. The end regions of the e.g. pH electrodes can extend into the cavity. Preferably, moreover, the above mentioned holding grating is arranged directly in front of the cathode. According to the invention, the membrane can for example be a combined electrode of an amperometric sensor (for example chloride) and one or more optical sensor (for example a pH or DO sensor). In this case the membrane consists of a element that is selectively permeable to gas and a sensor specific element which is activated by ions (for example pH) or gases (for example DO).

The invention relates furthermore to a sensor cap, composed of a cylindrical housing and a sensor membrane of the invention arranged in an end region of the housing, i.e. one of the above described sensor membranes.

For stabilizing the sensor membrane, the sensor cap preferably has a lid with a central opening. The lid is secured in an end region of the cylindrical housing, e.g. via a screw thread or a clip mechanism. The lid is so embodied that it covers the surface of the sensor membrane in an edge region facing toward the medium.

An embodiment of the sensor cap of the invention provides that the sensor membrane is arranged air tightly in the cylindrical housing.

Furthermore, the solution of the invention relates to an amperometric or optochemical sensor having the measuring membrane and/or the sensor cap of the invention. The essential components of an optochemical sensor are transmitting unit, receiving unit and control/evaluation unit, as already mentioned above. The particular embodiment of the individual sensor components is lastly always dependent on the actual measured variable (thus, for example, oxygen, nitrogen, carbon dioxide or chlorine in a solution can be determined qualitatively or quantitatively) and on the sensor-specific material suitable for determining the measured variable. Depending on application, the sensor-specific material is a phosphorescent colorant, a color indicator or a substance selectively permeable for the analyte to be determined.

Summarizing, the object of the invention is achieved by features including that the sensor element with the sensor-specific substance, respectively the sensor-specific substances, is arranged in a sandwich structure. The sandwich structure—especially in combination with a frontal and/or lateral covering—such as a cap—stabilizes the measuring membrane, so that a breaking out, respectively a dissolving out, of membrane parts is made greatly difficult or prevented. The sensor-specific substance can be a selectively permeable substance or a colorant. Advantageously, the matrix incorporating the sensor element is physically or chemically connected or bonded with the surface of the sensor element. For this, all methods known to those skilled in the art can be applied. Through the sandwich structure of the measuring membrane, a greater long time stability in the face of usual cleaning agents such as phosphoric acid, nitric acid, sodium hydroxide, sodium hypochlorite, sulfuric acid, perchloracetic acid or hydrogen peroxide is achieved. By means of the invention, the danger of membrane related, sensor downtime is greatly reduced. Experiments have confirmed that an sensor cap of the invention after being subjected to more than 50 cleaning cycles (30 min) in 90° C. hot sodium hydroxide (5%) remains both optically and mechanically intact as well as also gas and liquid tight.

The invention will now be explained in greater detail based on the appended drawing, the figures of which show as follows:

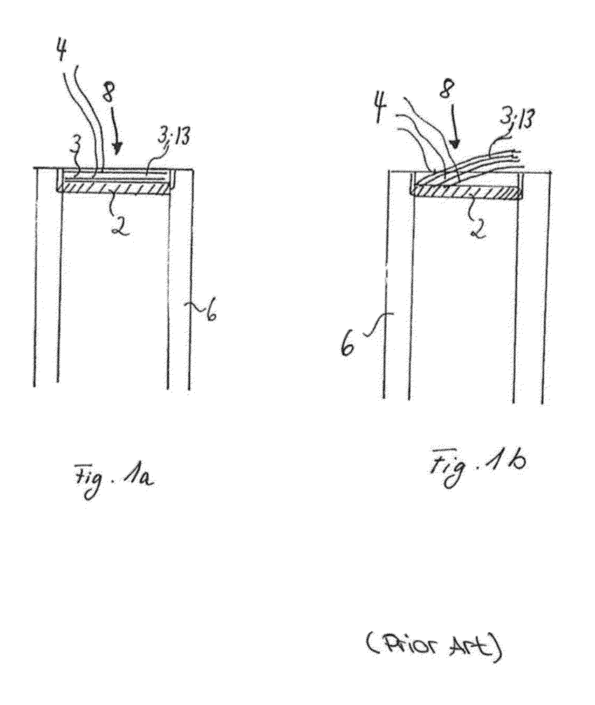

FIG. 1a a longitudinal section through a measuring membrane for determining an analyte, as adapted from the state of the art and secured in a housing,

FIG. 1b the measuring membrane of FIG. 1a after a large number of cleaning cycles,

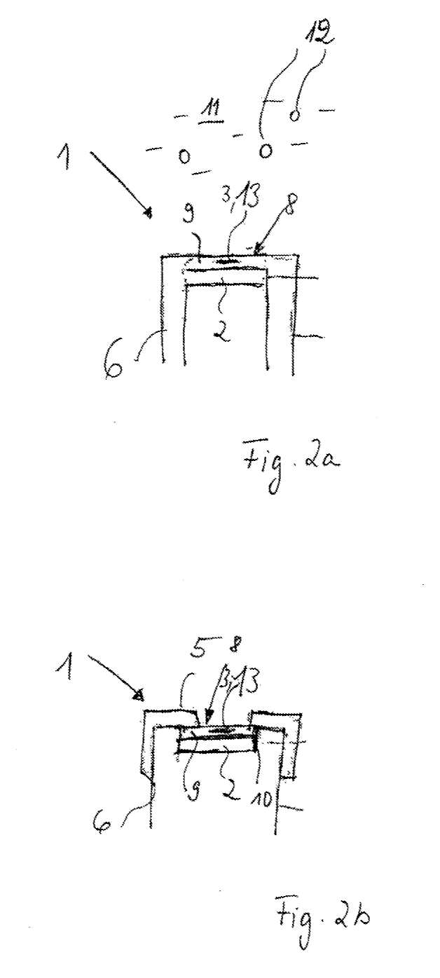

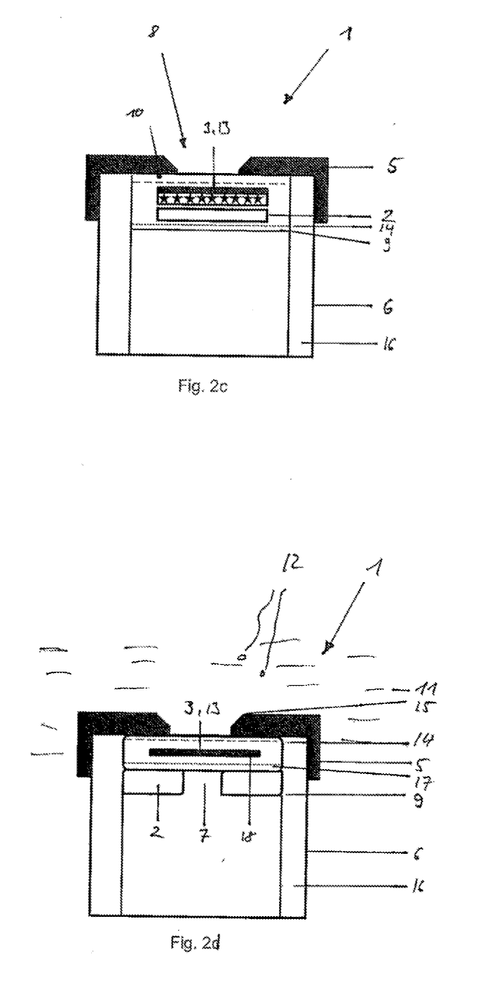

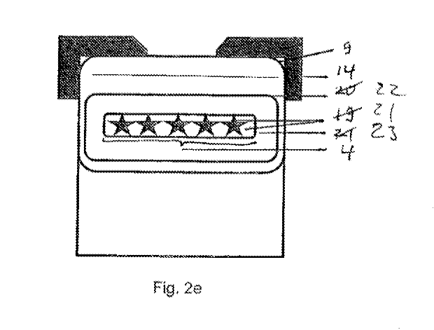

FIG. 2a a longitudinal section through a first embodiment of the measuring membrane of the invention, as secured in a housing,

FIG. 2b a longitudinal section through a sensor cap, in the case of which the measuring membrane shown in FIG. 2a is secured in the housing via a lid,

FIG. 2c a longitudinal section through a sensor cap, in the case of which a second embodiment of the measuring membrane of the invention is used, and

FIG. 2d a longitudinal section through a sensor cap, in which case of which a third embodiment of the measuring membrane of the invention is applied,

FIG. 2e a longitudinal section through a sensor cap, in which case of which a fourth embodiment of the measuring membrane of the invention is applied,

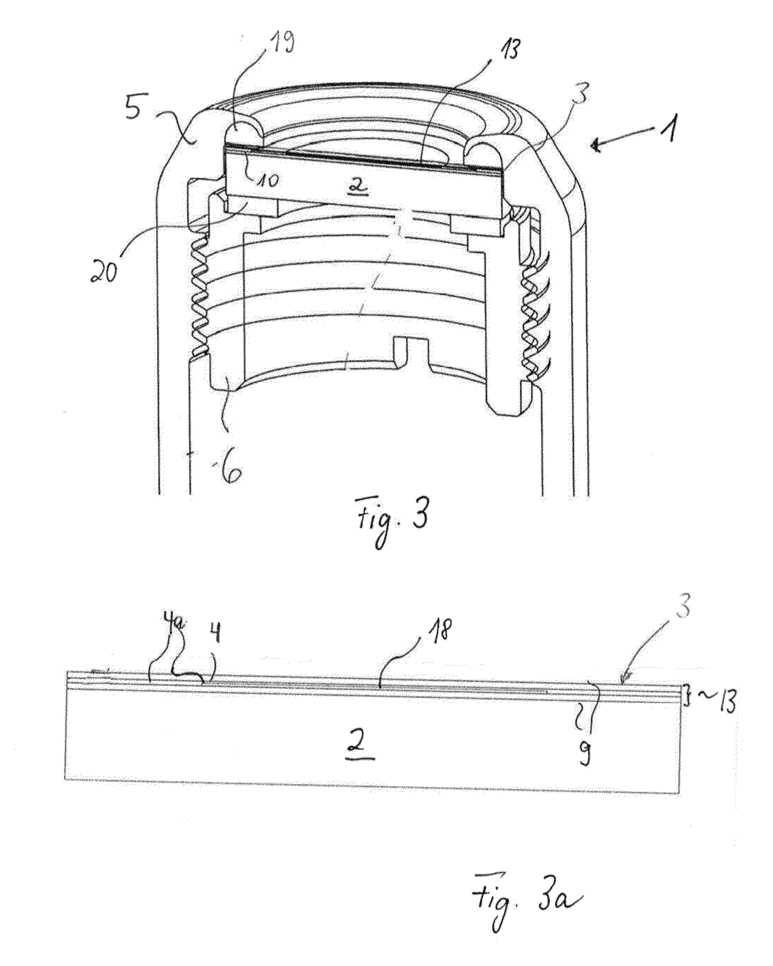

FIG. 3 a perspective view of a longitudinal section through a preferred sensor cap of the invention and

FIG. 3a a cross section through the sensor element of FIG. 3 with e.g. an optical spot.

FIG. 1a shows a longitudinal section through a sensor cap 1 known from the state of the art, composed of a cylindrical housing 6, which is closed in an end region toward the medium 11 by a measuring membrane 8 for determining an analyte 12. The analyte 12 to be determined or to be monitored can be, for example, an ion or gas contained in the medium 11. Measuring membrane 8 shown in FIG. 1a is adapted from the state of the art.

Such is composed of a sensor element 3 and a substrate material 2. The sensor element 3 can be so embodied that it is suitable either for optoelectric or for amperometric measurements. Further, the membrane 9 can be incorporated into a transparent wall of a reactor which is equipped with a mountable optical element (LED, photo diode, optical waveguide, etc.). The known sensor element 3 is a layer structure 13 formed of a plurality of different functional layers 4, wherein the functional layers 4 are matched to the particular application. Especially, the individual functional layers 4 are so formed that they correspond to the different requirements for the ability of the sensor to function. For example, a first functional layer 4 of the layer structure 13 e.g. provides a selective analyte permeability, a second functional layer 4 cares for the chemical and/or mechanical stability of the measuring membrane 8, and a third functional layer 4 emits in the case of corresponding excitation a luminescence, respectively a fluorescence- or phosphorescence signal at a certain wavelength and an analyte specific phase angle, or it absorbs light. The third functional layer 4, thus, carries the sensor-specific substance 18. The sensor-specific substance 18 is in the case of an optoelectrical sensor especially dependent on the analyte 12 to be determined or monitored in the medium 11.

The layer structure 13 with its lamellar construction is not without problems. As already earlier stated, it can occur that individual functional layers 4 of the layer structure 13 delaminate after a certain residence time in cleaning media—especially in the case of high temperatures (>40° C.) and in the case of extreme pH-values (pH<2, pH>12). This happening is shown in FIG. 1b. As soon as individual functional layers 4 of the layer structure 13 delaminate, the sensor, in which the measuring membrane 8 is integrated, malfunctions.

Added to this is the fact that usual substances accompanying the cleaning media, such as alcohols or oxidizing media, such as hypochlorites, can accelerate the aging of the measuring membrane 8. For example, aggressive gases can be released by the accompanying substances, which dissolve out parts of the known measuring membrane, whereby such loses its physical integrity. The dissolved out parts of the measuring membrane 8 lead, moreover, to a fouling of the medium 11, which cannot be tolerated, especially in the case of applications concerning food production.

FIG. 2a shows a first embodiment of a sensor cap 1 with the measuring membrane 8 of the invention. The measuring membrane is so arranged that it closes a cylindrical housing 6 on an end facing the medium 11. Measuring membrane 8 is so embodied that it is suitable for an optochemical sensor for determining or monitoring an analyte located in a medium 12. According to the invention, the measuring membrane 8 is composed of a substrate material 2 and a sensor element 3, which has at least one functional layer 4, which contains the sensor-specific substance 18. The sensor element 3 is completely embedded in a matrix 9. Matrix 9 is composed of a material, e.g. silicone, which at least in a portion facing the medium 11 and adjoining the sensor element 3 is permeable for the analyte 12. Matrix 9 is in the shown case connected in one of its surface regions physically or chemically with the substrate material 2. Preferably used for the matrix 9 is a material, which is chemically and physically stable relative to the medium 11 and/or usual cleaning media. Furthermore, the material of the matrix 9 is so selected that it is suitable for applications in the foods field.

The substrate material 2 can be, for example, glass, ceramic, polymer, a metal organic compound or zeolite. Furthermore, the substrate material 2 can have a hybrid structure, which is composed preferably of at least two of the aforementioned materials. The substrate material 2 gives the sensor membrane 8 of the invention the necessary stability. According to the invention, at least the sensor element 3 with its different foil-like or lamellar, functional layers 4 is embedded in the matrix 9 so as to form a sandwich structure. Additionally, the substrate material 2 can be connected areally with the matrix 9 or embedded in the matrix 9. The sandwich structure provides the measuring membrane 8 with a high stability.

In an embodiment, the sensor element 3 comprises a multi-layer system of at least two sensor components 21. The sensor components 21 comprise a polymer layer with embedded pigments, a shade layer, a layer to prevent photo bleaching with optical sensors, a layer to increase or decrease the permeability of the analyte 12, a support layer, a holding layer, a layer selectively permeable to the analyte 12, and/or a layer to buffer the pH-value.

FIG. 2b shows a longitudinal section through a sensor cap 1, into which the above described embodiment of the measuring membrane 8 of the invention is integrated. In the case of this embodiment, the measuring membrane 8 is reinforced supplementally by a terminal and/or lateral covering by means of a type of supplemental cap, which is referred to herein as a lid. In the illustrated case, thus the supplemental cap is a lid 5 having a screw thread and central opening 15, sized such that the measuring membrane is covered only in the edge region 10 of the lid 5. This design makes a dispelling of parts, respectively a delamination of individual functional layers 4, of the measuring membrane 8 very much more difficult, respectively completely prevents such. Advantageous in the case of this embodiment is that through a corresponding selection of the material of the matrix 9 in the contact region between lid 5 and the outer surface of the measuring membrane 8 facing the medium 11 a good sealing action is achieved, so that no medium 11 can penetrate into the interior of the cylindrical housing 6. An additional sealing, e.g. via a sealing ring 19, 20 (see FIG. 3), can be omitted.

FIG. 2c shows a longitudinal section through a sensor cap 1, in the case of which a second embodiment of the measuring membrane 8 of the invention is applied. In the case of this embodiment, both the sensor element 3 as well as also the substrate material 2 are completely integrated into the matrix 9: Both components 2, 3 are embedded in the matrix 9 in a sandwich structure. Additionally, in the case of this embodiment—likewise such as in the case of the embodiments shown in FIGS. 2a, 2b and 2d—a support grating 14 and/or a holding grating 17 can be provided, which lends the sensor membrane 8 of the invention, respectively the sensor cap 1 of the invention, additional stability. As shown in FIG. 2c, the matrix can also be arranged in a displaced manner to the substrate.

FIG. 2d shows a longitudinal section through a sensor cap 1 exhibiting a third embodiment of the measuring membrane 8 of the invention, which is especially suitable for use in amperometric sensors. This embodiment resembles strongly the embodiment shown in FIG. 2b, except that the substrate material 2 includes a cavity 7. Through this cavity 7, the reference electrolyte is brought closer to the sandwich structure of the invention. In addition, a holding grating 17 and a support grating 14 are arranged in the measuring membrane 8. The holding grating 17 is for mechanical stabilization and as barrier layer on the inner side of the sensor cap 1. The support grating 14 is for mechanical stabilization of the measuring membrane 8 on the side opposing the medium 11. Moreover, it is advantageous in the case of the embodiment shown in FIG. 2d that the matrix 9 in this case simultaneously performs the function of a sealing element. For example, with suitable choice of the material of the matrix 9, a sealing ring can be omitted.

FIG. 2e shows a longitudinal section through a sensor cap 1 exhibiting a fourth embodiment of the measuring membrane 8 of the invention, which shows a multi-embedded matrix. The sensor layer comprises a sub matrix 23 comprising pigment, micro sphere and polymer. The sub matrix 23 is embedded into a transparent intermediate matrix 22, which protects from radial offense from the medium 11 or from singlet oxygen. Intermediate matrix 22 and sub matrix 23 are together with another protection layer, for example a stabilizing fiberglass mesh, embedded into the already mentioned matrix 9.

In the sub matrix 23, the analytical functional layer 4 is protected from photo bleaching and radical gases and ions from the medium 11 by the intermediate matrix 22 and another matrix 9 protecting from mechanical offense. The single matrices can comprise different hydrophobia.

FIG. 3 shows in perspective view a longitudinal section through a preferred form of embodiment of the sensor cap 1 of the invention. FIG. 3a shows a cross section through the sensor element 3 of FIG. 3. Measuring membrane 8 is, such as indicated above, depending on embodiment and depending on sensor specific functional layer, suitable for any optochemical or any amperometric sensor for determining or monitoring an analyte 12 located in a medium 11. Preferably, the concept of the invention is used for oxygen measurement in aqueous solutions.

Measuring membrane 8 includes a sensor element 3, which usually is composed of a plurality of functional layers 4, 4a. The essential functional layer 4 contains the sensor-specific substance 18. Furthermore, a functional layer 4a is embodied as a protective layer, which at least partially absorbs disturbing radiation incoming from the environment. Additional protective layers known from the state of the art can, depending on application, be provided. Furthermore, measuring membrane 8 includes substrate material 2.

According to the invention, in the illustrated case, the sensor element 3 is completely embedded in a matrix 9, wherein the matrix 9 is composed of a material, which is permeable for the analyte 12, at least in a portion facing the medium 11 and adjoining the sensor element 3. Matrix 9 is connected physically or chemically in its lower surface regions with the substrate material 2. It has already been mentioned above that the substrate material 2 can also be embedded partially or completely in the matrix 9. Then the material of the matrix 9 must be permeable for the analyte 12, at least in a portion facing the analyte 12.

Measuring membrane 8 is in the shown case releasably secured in the sensor cap 1. For sealing the sensor cap 1 relative to the medium 11, sealing rings 19, 20 are provided in the upper and lower edge regions 10 of the measuring membrane 8, via which the measuring membrane 8 is sealed against the lid 5, respectively the housing 6, of the sensor (not shown in detail). Preferably, the material of the matrix 9 can be so selected that it has a certain flexibility, so that upon integration into the sensor cap 1 a sealing action is achieved. In given cases, one of the two seals 19, 20 or even both of the seals 19, 20 can then be omitted. In the illustrated case, the sensor cap 1 engages via a screw thread with the housing 6 of the sensor, so that the sensor can, when required, be easily replaced and/or cleaned.

### LIST OF REFERENCE CHARACTERS

1 sensor cap
2 substrate layer
3 sensor element
4 functional layer
5 sensor lid
6 housing
7 cavity
8 measuring membrane
9 matrix
10 edge region
11 medium
12 analyte
13 layer structure
14 support grating
15 opening
16 end region
17 holding grating
18 sensor-specific substance
19 seal/sealing ring
20 seal/sealing ring
21 sensor components
22 Intermediate matrix
23 sub matrix

1-21. (canceled)

22. A measuring membrane for an optochemical or amperometric sensor for determining or monitoring an analyte located in a medium, comprising:
a substrate material; and
a sensor element, which has at least one functional layer with a sensor-specific substance, wherein:
said sensor element is embedded completely in a matrix; and
said matrix is composed of a material, which at least in a portion facing the medium and adjoining said sensor element is permeable for the analyte.

23. The measuring membrane as claimed in claim 22, wherein:
said matrix is connected in one of its surface regions physically or chemically with said substrate material.

24. The measuring membrane as claimed in claim 22, wherein:
said substrate material is at least partially embedded in said matrix and, in given cases, is permeable, at least in portions, for the analyte.

25. The measuring membrane as claimed in claim 22, wherein:
said sensor element has a layer structure and is composed of at least two functional layers; and
one of the functional layers contains the sensor-specific substance.

26. The measuring membrane as claimed in claim 22, wherein:
said sensor-specific substance is so embodied that it is selectively permeable for the analyte.

27. The measuring membrane as claimed in claim 22, wherein:
said sensor-specific substance is so embodied that it is changed in at least one of its chemical or physical properties by contact with the analyte, and wherein the change is detectable.

28. The measuring membrane as claimed in claim 22, wherein:
the material of said matrix is, at least in portions, permeable for the analyte.

29. The measuring membrane as claimed in claim 22, wherein:
used as material for said matrix is a material, which is chemically and physically stable relative to the measured medium and/or a cleaning medium.

30. The measuring membrane as claimed in claim 22, wherein:
used as material for said matrix is a material, which is suitable for applications in the foods field.

31. The measuring membrane as claimed in claim 22, wherein:
said substrate material is composed preferably of one of the following materials: glass, ceramic, polymer, metal organic compound, and zeolite; or
said substrate material has a hybrid structure and is preferably composed of at least two of the aforementioned materials.

32. The measuring membrane as claimed in claim 23, wherein:
said substrate material is embedded at least partially in said matrix and is permeable for the analyte.

33. The measuring membrane as claimed in claim 22, wherein:
said substrate material has a cavity in a region, in which said sensor element is arranged.

34. The measuring membrane as claimed in claim 22, further comprising:
a support grating and/or a holding grating, which are/is embedded in said matrix.

35. The measuring membrane as claimed in claim 22, wherein:
said sensor element is a multi-layer system comprising at least two sensor components.

36. The measuring membrane as claimed in claim 35, wherein:
said sensor components comprise a polymer layer with embedded pigments, a shade layer, a layer to prevent photo bleaching with optical sensors, a layer to increase or decrease the permeability of the analyte, a support layer, a holding layer, a layer selectively permeable to the analyte, and/or a layer to buffer the pH-value.

37. The measuring membrane as claimed in claim 35, wherein:
the multi-layer system comprising at least two sensor components is embedded into a sub matrix;
said sub matrix is embedded into an intermediate matrix, whereas said sub matrix and/or said intermediate matrix are embedded into said matrix.

38. The measuring membrane as claimed in claim 32, wherein:
at least one of the matrices: said matrix, said sub matrix and/or said intermediate matrix comprise materials with different hydrophobia, especially Teflon or solgel.

39. A sensor cap comprising:
a cylindrical housing; and
arranged in an end region of said housing, a measuring membrane, comprising: a measuring membrane for an optochemical or amperometric sensor for determining or monitoring an analyte located in a medium, comprising: a substrate material; and a sensor element, which has at least one functional layer with a sensor-specific substance, wherein: said sensor element is embedded completely in a matrix; and said matrix is composed of a material, which at least in a portion facing the medium and adjoining said sensor element is permeable for the analyte.

40. The sensor cap as claimed in claim 39, further comprising:
a lid with a central opening, which is securable in an end region of said cylindrical housing and which covers the surface of said measuring membrane in an edge region facing toward the medium.

41. The sensor cap as claimed in claim 39, wherein:
said measuring membrane is arranged air tightly in the sensor cap.

42. An amperometric or optochemical sensor having a measuring membrane comprising: a substrate material; and a sensor element, which has at least one functional layer with a sensor-specific substance, wherein: said sensor element is embedded completely in a matrix; and said matrix is composed of a material, which at least in a portion facing the medium and adjoining said sensor element is permeable for the analyte, or a sensor cap, comprising: a cylindrical housing; and arranged in an end region of said housing, a measuring membrane, comprising: a measuring membrane for an optochemical or amperometric sensor for determining or monitoring an analyte located in a medium, comprising: a substrate material; and a sensor element, which has at least one functional layer with a sensor-specific substance, wherein: said sensor element is embedded completely in a matrix; and said matrix is composed of a material, which at least in a portion facing the medium and adjoining said sensor element is permeable for the analyte.
